(19) United States
(12) Patent Application Publication
(10) Pub. No.: US 2003/0203258 A1
(43) Pub. Date: Oct. 30, 2003

(54) Fuel cell system with liquid cooling device

(76) Inventors: Jefferson Ys Yang, Orange, CA (US); Yaw-Chung Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/417,080

(22) Filed: Apr. 17, 2003

(30) Foreign Application Priority Data
Apr. 24, 2002 (TW) 91205611

(51) Int. Cl. H01M 8/04; H01M 16/00

(52) U.S. Cl. 429/25; 429/26; 429/9; 429/24

(57) ABSTRACT

A fuel cell system includes a fuel cell stack, an air supply system including a blower for driving the air to the fuel cell stack and an air humidifier for humidifying the air supplied to the fuel cell stack, a hydrogen supply system including a hydrogen storage and a pressure regulating device, and a hydrogen recirculator for receiving excessive hydrogen from the fuel cell stack and forcing the hydrogen back into the fuel cell stack in order to induce a hydrogen flow inside the fuel cell stack, a coolant circulation system supplying low temperature coolant to the fuel cell stack for absorbing heat from the fuel cell stack and including a coolant reservoir in which the coolant is stored, a pump driving the circulation of the coolant, a radiator for removing heat from the high temperature coolant and converting the high temperature coolant into the low temperature coolant. The coolant reservoir includes a ventilation device for removing air bubbles from the coolant. The coolant circulation system includes a heat exchanger for transferring heat from the high temperature coolant to the hydrogen storage. A control circuit electrically controls the flow and pressure regulating device, the blower, the pump and the fan.

### BACKGROUND OF THE INVENTION

1. Field of the Invention

The present invention relates generally to a fuel cell system, and in particularly to a fuel cell system comprising a liquid cooling device for improving performance thereof.

2. Description of the Prior Art

Fuel cell power system is capable of generating electrical power energy by means of electrochemical reaction between a fuel, such as hydrogen and methanol, and an oxidizer, such as oxygen. The fuel cell is classified, based on the electrolyte thereof, as proton exchange membrane fuel cell or polymer electrolyte membrane fuel cell, abbreviated as PEMFC or PEM, alkaline fuel cell (AFC), phosphoric acid fuel cell (PAFC), molten carbonate fuel cell (MCFC) and solid oxide fuel cell (SOFC).

Among these known fuel cells, the PEMFC is the best-developed technique, having the advantages of low operation temperature, fast start-up and high power density. Thus, the PEMFC is very suitable for transportation vehicles and power generation systems, such as home power systems and other portable and stationary power generation systems.

Fuel cells operating in the high power output condition generally generate large amount of heats. Thus, water cooling technique is commonly employed in the fuel cell system for removal of heat therefrom. FIG. 1 of the attached drawings shows an example of conventional fuel cell systems. The conventional fuel cell system comprises a fuel cell stack 102 to which oxygen and hydrogen are supplied for the electrochemical reaction.

In suitable moisturized condition, the electrochemical reaction between oxygen and hydrogen is highly improved. Therefore, to enhance performance, a humidifier 104 is arranged in a passage through which hydrogen is conveyed to the fuel cell stack 102 for humidifying the hydrogen. In a heavy load condition, the operation temperature of the fuel cell stack 102 rises to approximately 60° C.-80° C. At this time, a large quantity of dry air that contains oxygen is drawn in by a blower 106 and driven to the fuel cell stack 102 for reacting with hydrogen. However, this speeds up the loss of water from the electrolyte membrane and low humidity of the fuel cell stack 102 results to poor performance.

Further, the fuel cell stack 102 is cooled by water in reservoir 108. The water may get frozen and becomes solid ice in a cold environment, and is inefficient or even unable to cool the fuel cell stack 102. A coolant circulation is formed between the water reservoir 108 and the fuel cell stack 102 which comprises a water reservoir 108 for supplying cooling water, a pump 110 for driving the water from the water reservoir 108, a heat exchanger 112 for exchanging heat between the cooling water and a hydrogen storage for heating the hydrogen storage and a radiator 114 for removing heat from the cooling water. As the water reservoir 108 is not provided with ventilation means for expelling air, the bubbles trapped may induce blockage of the coolant circulation passage. Consequently, the cooling water cannot be properly conveyed to the fuel cell stack 102.

It is thus desired to provide a fuel cell system that overcomes the above-discussed disadvantages of the prior art.

### SUMMARY OF THE INVENTION

Thus, an object of the present invention is to provide a liquid-cooling fuel cell system that comprises a device for humidifying air and supplying the air to a fuel cell stack to ensure the high performance of fuel cell stack.

Another object of the present invention is to provide a liquid-cooling fuel cell system comprising a coolant reservoir storing coolant therein for cooling the fuel cell stack, wherein the reservoir is provided with a ventilation device for removing air bubbles generated inside and entraining the coolant flow, and thus preventing the coolant circulation from being blocked by the air bubbles.

To achieve the above objects, in accordance with the present invention, there is provided a fuel cell system comprising a fuel cell stack, an air supply system including a blower for driving the air to the fuel cell stack and an air humidifier for humidifying the air supplied to the fuel cell stack, a hydrogen supply system comprising a hydrogen storage in which hydrogen is stored and from which a hydrogen flow is supplied to the fuel cell stack and a pressure regulating device for regulating the hydrogen flow, and a hydrogen recirculator for receiving excessive hydrogen from the fuel cell stack and forcing the hydrogen back into the fuel cell stack in order to induce a hydrogen flow inside the fuel cell stack, a coolant circulation system supplying low temperature coolant to the fuel cell stack for absorbing heat from the fuel cell stack and including a coolant reservoir in which the coolant is stored, a pump driving the circulation of the coolant, a radiator for removing heat from the high temperature coolant and converting the high temperature coolant into the low temperature coolant. The coolant reservoir comprises a ventilation device for removing air bubbles from the coolant. The coolant circulation system comprises a heat exchanger for transferring heat from the high temperature coolant to the hydrogen storage. A control circuit electrically controls the flow and pressure regulating device, the blower, the pump and the fan.

The fuel cell system provides humidified air that has sufficient moisture content for performing chemical reaction at high rate even at heavy load condition, thereby enables the fuel cell stack to provide large working current. Unreacted and excessive hydrogen is recovered and circulated back to the fuel cell stack, and recycle of hydrogen efficiently enhances the chemical reaction inside the fuel cell stack. Further, the ventilation device effectively expels air bubbles entraining the coolant flow thereby eliminating blockage of the coolant flow. In addition, an anti-freeze agent may be added in the coolant, which renders resistance to low temperature when the fuel cell system is used in cold areas.

### BRIEF DESCRIPTION OF THE DRAWINGS

The present invention will be apparent to those skilled in the art by reading the following description of a preferred embodiment thereof, with reference to the attached drawings, in which:

FIG. 1 is a system block diagram of a conventional fuel cell system;

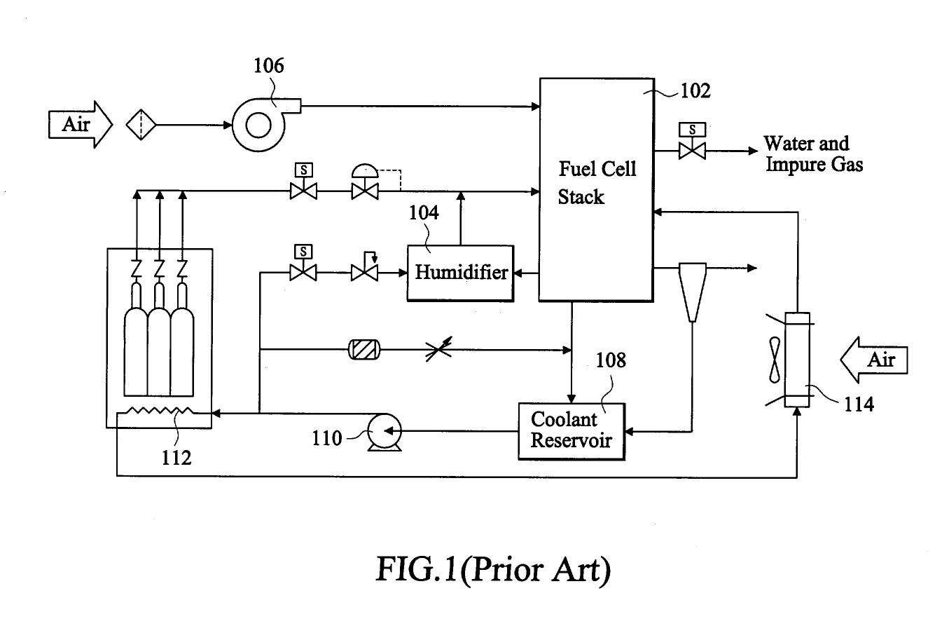

FIG. 2 is system block diagram of a fuel cell system constructed in accordance with the present invention;

FIG. 3 is a block diagram of an application of the fuel cell system of the present invention in an electrical vehicle;

FIG. 4 is a block diagram of another application of the fuel cell system of the present invention in an alternating current power generation system; and

FIG. 5 is a block diagram of a further application of the fuel cell system of the present invention in a direct current power generation system.

### DETAILED DESCRIPTION OF THE PREFERRED EMBODIMENTS

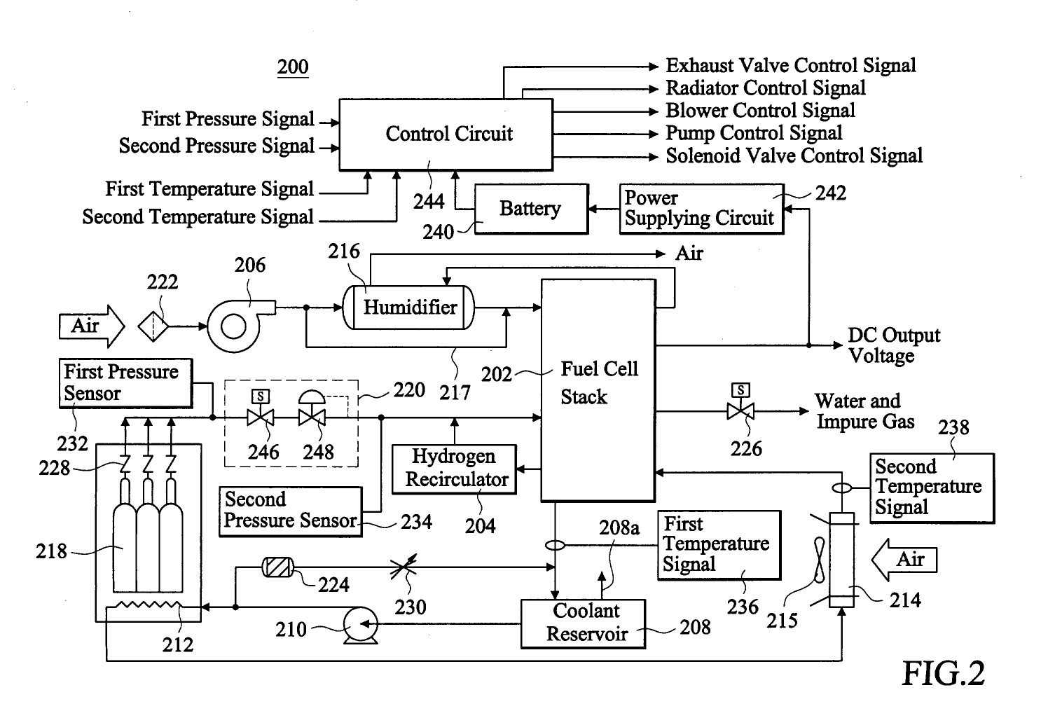

With reference to the drawings and in particular to FIG. 2, a fuel cell system in accordance with the present invention, generally designated with reference numeral 200, comprises a fuel cell stack 202, which receives hydrogen from a hydrogen storage 218 that may comprise a number of alloy based hydrogen canisters or pressurized hydrogen canisters, each connected to the fuel cell stack 202 by a valve 228. The supply of the hydrogen from the hydrogen storage 218 to the fuel cell stack 202 is regulated by a flow and pressure regulating device 220. Also a hydrogen recirculator 204 is connected to the fuel cell stack 202 for recirculation of hydrogen back into the fuel cell stack 202.

Air is drawn through an air filter 222 into the fuel cell system 200 by a blower 206. Impurities contained in the air are removed by the filter 222. The air is then conveyed through an air humidifier 216 to increase the humidity thereof. The air is then supplied to the fuel cell stack 202 for reaction with the hydrogen in order to generate electricity with water and heat as byproducts of the reaction. A bypass connection 217 is connected between the air blower 206 and the fuel cell stack 202 in parallel to the air humidifier 216 for directly supplying air containing oxygen to the fuel cell stack 202, and thus enables the air to maintain a desired humidity to the fuel cell stack 202. Undesired water and impurity gas may be expelled from the fuel cell stack 200 through an exhaust valve 226 to the surroundings.

The air humidifier 216 also receives humid air from the fuel cell stack 202, which carries a great amount of moisture since water is continuously and rapidly generated by reaction in the fuel cell stack 202. The fresh air drawn by the air blower 206 can absorb water from the humid air in the humidifier 216 to obtain the desired humidity. The air is then fed to the fuel cell stack 202. The moisture contained in the outlet air efficiently promotes the reaction in the fuel cell stack 202.

In addition, when the temperature of the fuel cell stack 202 reaches 40-60° C. or when the fuel cell stack 202 is in a heavy load, a large amount of fresh air is drawn in by the air blower 206 through the filter 222. After passing through the air humidifier 216, the bulk air is properly humidified by the humid air from the fuel cell stack 202. In other words, the more air is drawn into the fuel cell system 200, the more water is generated in the fuel cell stack 202 and circulated to the humidifier 216 to humidify the fresh air. Thus, the fuel cell stack 202 does not run short of water and the performance thereof can be maintained.

The supply of hydrogen that is stored in the canisters of the hydrogen storage 218 is controlled by the valves 228, which selectively stop the hydrogen flow from each canister. The hydrogen flow is controlled and regulated by the flow and pressure regulating device 220 which comprises a solenoid valve 246 and a pressure regulating valve 248. The solenoid valve 246 is controlled by a control circuit 244 such that it is selectively turned on or off for the flowing of the hydrogen from the hydrogen storage 218, while the pressure regulating valve 248 regulates the pressure of the hydrogen flowing through the solenoid valve 246 to the fuel cell stack 202.

A first pressure sensor 232 is mounted between the hydrogen storage 218 and the flow and pressure regulating device 220, at a high pressure side (upstream side) of the flow and pressure regulating device 220. The first pressure sensor 232 detects the hydrogen pressure of the high pressure side of the flow and pressure regulating device 220 and generates, in response to the detection, a first pressure signal indicating the hydrogen pressure of the high pressure side of the hydrogen supplying pipeline to the control circuit 244, whereby the control circuit 244 controls the solenoid valve 246 based on the electrical signal. A second pressure sensor 234 is mounted between the flow and pressure regulating device 220 and the fuel cell stack 202, at a low pressure side (downstream side) of the flow and pressure regulating device 220. The second pressure sensor 234 detects the hydrogen pressure of the low pressure side of the flow and pressure regulating device 220 and generates a second pressure signal indicating the hydrogen pressure of the low pressure side of the hydrogen supplying pipeline to the control circuit 244. Accordingly, the control circuit 244 controls the turn on/off of the solenoid valve 246, and thereby the passage for the hydrogen flow is opened or closed. Excessive pressure of the hydrogen is avoided in order to secure the fuel cell system from the damage caused by the excessive hydrogen pressure.

The hydrogen recirculator 204 draws unreacted and excessive hydrogen from the fuel cell stack 202 and forces the hydrogen back into the fuel cell stack 202. This induces a forced flowing of hydrogen through the fuel cell stack 202, and subsequently hydrogen is uniformly distributed. Thereby, the reaction between the hydrogen and the oxygen is promoted and the performance of the fuel cell is improved.

The exhaust valve 226, which may be a solenoid valve, is controlled by the control circuit 244 to remove undesired water and impurities from the fuel cell stack 202 at a regular interval. This maintains the purity of the hydrogen inside the fuel cell stack 202. Also, accumulation of water inside hydrogen passages can be eliminated in order to maintain the performance of the fuel cell stack 202.

A coolant circulation system comprising a coolant reservoir 208, a pump 210, a heat exchanger 212 and a radiator 214 circulates a coolant through the fuel cell stack 202. Low temperature coolant flows into the fuel cell stack 202 and absorbs heat from the fuel cell stack 202, and high temperature coolant flows out of the fuel cell stack 202 and is guided to the coolant reservoir 208. Air bubbles entraining the coolant may be expelled out of the fuel cell system 200 via a ventilation hole 208a or ventilation device formed in the reservoir 208. The air bubbles, if not properly removed from the coolant, may impede the coolant passage and may cause no load running of the pump 210. The coolant may comprise water containing an anti-freeze agent, such as ethylene glycol. Such a coolant is capable to tolerate low temperature without freezing, and therefore, enables the use of the fuel cell system 200 in a low temperature environment and cold area.

The high temperature coolant received in the coolant reservoir 208 is driven by the pump 210 to circulate. A filter 224 is connected to the circulation path of the coolant for removing impurity from the coolant. A valve 230 is connected between the filter 224 and the coolant reservoir 208 for controlling the flow rate of the filtered coolant.

The heat exchanger 212 is arranged inside the hydrogen storage 218 for absorbing heat from the high temperature coolant for heating of the hydrogen storage canisters. The alloy based hydrogen canister lowers its temperature when releasing hydrogen from the alloy. The high temperature coolant supplements heat to the hydrogen storage canister and maintains it at a proper temperature for normal supply of hydrogen to the fuel cell stack 202. The coolant is then conveyed to the radiator 214 for further removing heat therefrom. A fan 215 is arranged to cause an air flow through the radiator 214 for efficiently removing heat from the high temperature coolant and converting the high temperature coolant into the low temperature coolant for directly supplying to the fuel cell stack 202 and effectively lowering down the temperature of the fuel cell stack 202.

A first thermocouple 236 or other temperature sensor is mounted between the fuel cell stack 202 and the coolant reservoir 208, at the high temperature side (downstream side) of the fuel cell stack 202, to detect the temperature of the coolant and provides a first temperature signal indicating the temperature of the coolant at the high temperature side of the fuel cell stack 202 to the control circuit 244. A second thermocouple 238 is mounted between the fuel cell stack 202 and the radiator 214 at the low temperature side (upstream side) of the fuel cell stack 202, to detect the temperature of the coolant and provides a second temperature signal indicating the temperature of the coolant at the upstream side of the fuel cell stack 202 to the control circuit 244. The control circuit 244 controls the operation of the fan 215 in accordance with the first temperature signal and the second temperature signal in order to maintain the operation temperature of the fuel cell stack 202.

The control circuit 244 electrically controls the operation of the flow and pressure regulating device 220 to regulate the hydrogen flowing into the fuel cells stack 202. The control circuit 244 also electrically controls the blower 206 to control the air flowing through the air humidifier 216 and into the fuel cell stack 202. The control circuit 244 electrically controls the exhaust valve 226 for expelling impurities and water from the fuel cell stack 202. The control circuit 244 electrically controls the pump 210 that circulates the coolant through the fuel cell stack 202 and the fan 215 of the radiator 214 that removes heat from the coolant in order to maintain the temperature of the fuel cell stack 202. In addition, the control circuit 244 may conduct a self-diagnosis, such as detection of the hydrogen pressure of the hydrogen storage 218, and examination of the operation conditions of the blower 206, the pump 210, the fan 215, the solenoid valve 246, the exhaust valve 226, the fuel cell stack 202 and, if desired, the control circuit 244 itself.

A backup battery set 240 may be incorporated in the fuel cell system 200 for powering the control circuit 244 in starting up the fuel cell system 200. The backup battery set 240 may comprise a lead-acid battery or the like, which supplies electricity to the control circuit 244 when the fuel cell system 200 is just started. The power of the backup battery 240 is also supplied to other devices, such as the blower 304, the pump 210, the cooling fan 215, the solenoid valve 246 and the exhaust valve 226 for the startup operation. Once the fuel cell system 200 is properly started, electricity supplied from the fuel cell stack 202 recharges the backup battery set 240 via a power supplying circuit 242. The power supplying circuit 242 converts the DC output voltage generated from the fuel cell stack 202 into a working voltage for the control circuit 244 and the backup battery set 240.

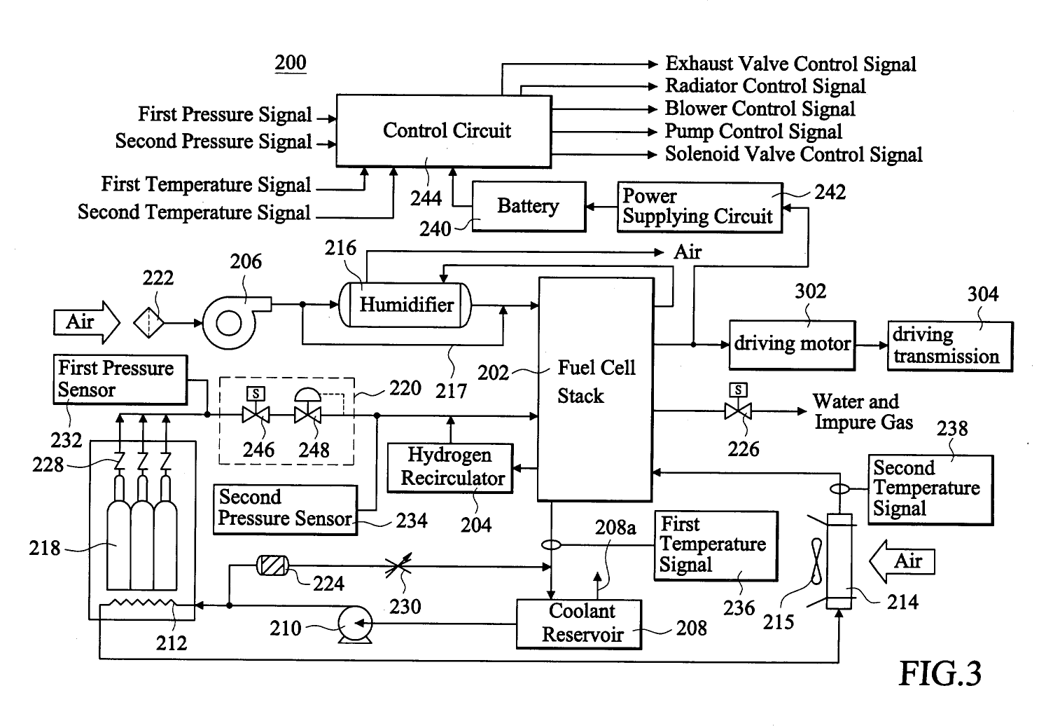

The fuel cell system 200 comprising a liquid cooling device is commonly employed in applications requiring large power, such as electrical vehicles and small-sized electrical generators. FIG. 3 shows an application of the fuel cell system 200 of the present invention in an electrical vehicle wherein the fuel cell stack 202 of the fuel cell system 200 generates a DC output voltage, which is applied to a driving motor 302 for driving a transmission 304 of the electrical vehicle. It is noted that the components and parts of the fuel cell system 200 of the present invention that is illustrated in FIG. 2 are completely incorporated in FIG. 3 for clarity.

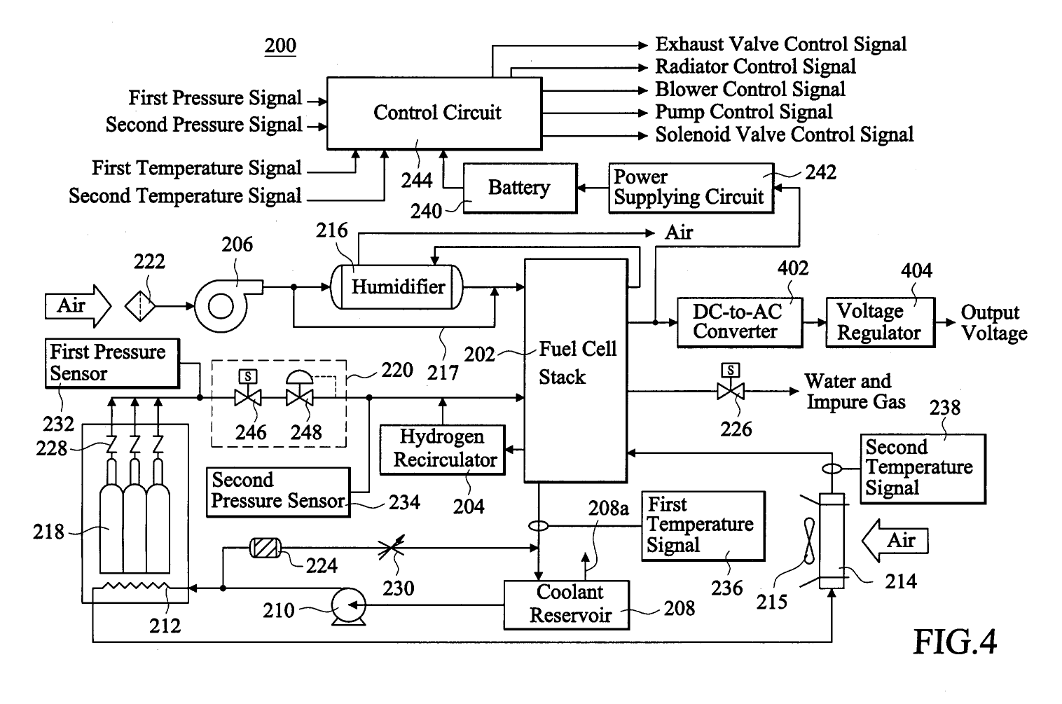

FIG. 4 shows another application of the fuel cell system 200 of the present invention in an alternating current generator, which may be portable or stationary. The fuel cell stack 202 of the fuel cell system 200 generates a DC output voltage, which is applied to a DC-to-AC converter 402 for converting the direct current generated by the fuel cell stack 202 into an AC output voltage. The AC output voltage may be further regulated by a voltage regulator 404. Voltage of the alternating current so generated may be changed as desired. The components and parts of the fuel cell system 200 of the present invention illustrated in FIG. 2 are completely incorporated in FIG. 4 for clarity.

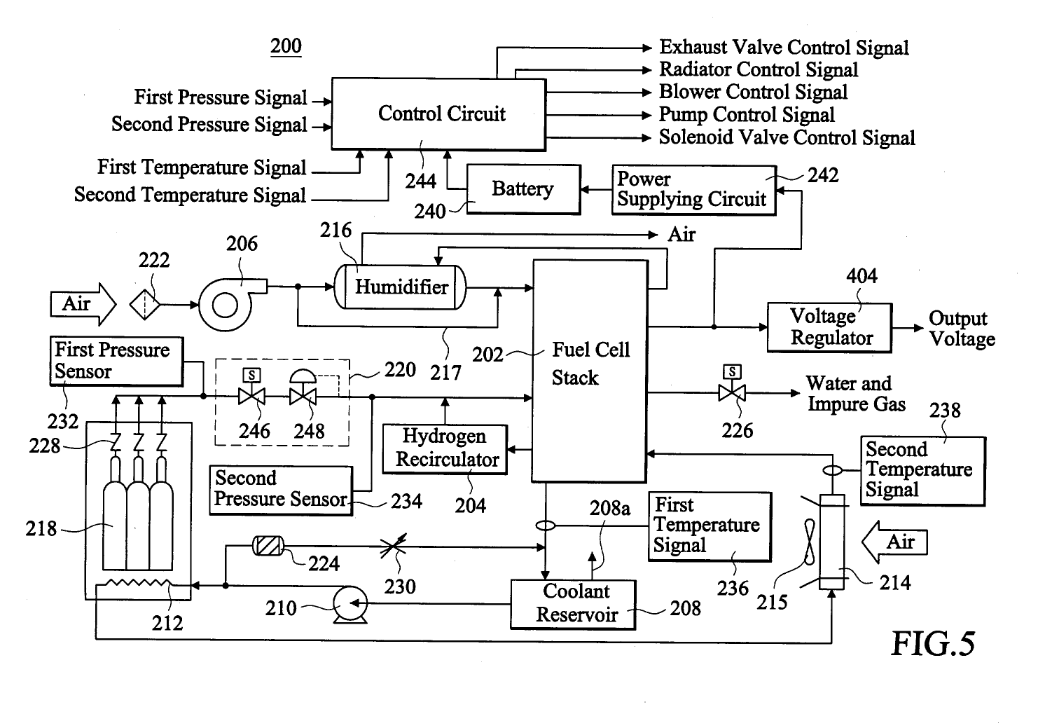

FIG. 5 shows a further application of the fuel cell system 200 of the present invention in a direct current generator, which may be portable or stationary. The fuel cell stack 202 of the fuel cell system 200 generates a DC output voltage, which is directly applied to a voltage regulator 404 for voltage regulation. It is noted that the components and parts of the fuel cell system 200 of the present invention illustrated in FIG. 2 are completely incorporated in FIG. 5 for clarity.

To this point, it can be noted that the fuel cell system of the present invention provides humidified air containing oxygen to the fuel cell stack for enhancing the reaction and to avoid insufficiency of water in case of heavy loads. It is also noted that the recirculation of the hydrogen back to the fuel cell stack helps promoting elctro-chemical reaction inside the fuel cell stack. In addition, the ventilation hole or ventilation device formed in the coolant reservoir removes air bubbles entraining the coolant flow and effectively prevents the coolant flow from being blocked by the air bubbles. The anti-freeze agent in the coolant allows for use of the fuel cell system in extreme low temperature condition and cold areas without any solidification of the coolant and thus maintaining the operability of the system in the cold area.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A fuel cell system comprising:
a fuel cell stack;
an air supply system supplying an air flow to the fuel cell stack, comprising a blower for driving the air to the fuel cell stack and an air humidifier for humidifying the air supplied to the fuel cell stack;
a hydrogen supply system supplying hydrogen to the fuel cell stack, comprising a hydrogen storage in which hydrogen is stored and from which a hydrogen flow is supplied to the fuel cell stack, and a pressure regulating device for regulating the hydrogen flow, a hydrogen recirculator for receiving excessive hydrogen from the fuel cell stack and forcing the hydrogen back into the fuel cell stack in order to induce a hydrogen flow inside the fuel cell stack; and
a coolant circulation system supplying a low temperature coolant to the fuel cell stack for absorbing heat from the fuel cell stack and becoming high temperature coolant, comprising a coolant reservoir in which the coolant is stored, a pump driving the circulation of the coolant, a radiator for removing heat from the high temperature coolant and converting the high temperature coolant into the low temperature coolant, the coolant reservoir comprising a ventilation device for removing air bubbles from the coolant, the coolant circulation system further comprising a heat exchanger for transferring heat from the high temperature coolant to the hydrogen storage, the radiator comprising a fan for generating an air flow therethrough to removing heat from the coolant; and
a control circuit electrically controlling the flow and pressure regulating device, the blower, the pump and the fan.

2. The fuel cell system as claimed in claim 1, further comprising:
a battery set powering the control circuit;
a power supplying circuit for receiving and converting a direct current from the fuel cell stack into a working voltage;
an exhaust valve controlled by the control circuit to expel impurities and water from the fuel cell stack;
a first filter for removing an impurity from the air drawn by the blower;
a valve mounted to the hydrogen storage for selectively shutting down the hydrogen storage;
a first pressure sensor mounted between the hydrogen storage and the flow and pressure regulating device for detecting hydrogen pressure in a high pressure side of the flow and pressure regulating device and generating a first pressure signal corresponding to the hydrogen pressure to the control circuit;
a second pressure sensor mounted between the flow and pressure regulating device and the fuel cell stack for detecting hydrogen pressure in a low pressure side of the flow and pressure regulating device and generating a second pressure signal corresponding to the hydrogen pressure to the control circuit;
a first temperature sensor mounted between the fuel cell stack and the coolant reservoir to detect a temperature of the high temperature coolant and generating a first temperature signal to the control circuit;
a second temperature sensor mounted between the fuel cell stack and the radiator to detect a temperature of the low temperature coolant and generating a second temperature signal to the control circuit;
a second filter for removing an impurity from the high temperature coolant; and
a valve for controlling a flow rate of the coolant.

3. The fuel cell system as claimed in claim 2, wherein the exhaust valve comprises a solenoid valve.

4. The fuel cell system as claimed in claim 1, wherein the air humidifier receives a humidity from the fuel cell stack and transfer the water to the air drawn by the air blower.

5. The fuel cell system as claimed in claim 1, wherein the hydrogen storage comprises an alloy based hydrogen storage canisters.

6. The fuel cell system as claimed in claim 1, wherein the flow and pressure regulating device comprises:
a solenoid valve controlled by the control circuit for selectively shutting down the hydrogen flow; and
a pressure regulating valve for regulating pressure of the hydrogen flow.

7. The fuel cell system as claimed in claim 1, wherein the control circuit electrically controls the flow and pressure regulating device for regulating the hydrogen flow toward the fuel cell stack, the control circuit controls the blower to control the air flowing through the air humidifier, the control circuit electrically controls the pump that circulates the coolant, the control circuit electrically controls the fan for generating the air flow, the control circuit electrically receives the high pressure signal, the low pressure signal, the high temperature signal and the low temperature signal and the control circuit performs a self-diagnosis procedure.

8. The fuel cell system as claimed in claim 7, wherein the self-diagnosis procedure comprises detection of the hydrogen pressure of the hydrogen storage, and examination of the operation conditions of the blower, the pump, the fan, the fuel cell stack and the control circuit.

9. The fuel cell system as claimed in claim 1, wherein a bypass is formed between the air blower and the fuel cell stack to directly supply air containing oxygen to the fuel cell stack.

10. The fuel cell system as claimed in claim 1, wherein the coolant comprises a water containing anti-freeze agent.

11. The fuel cell system as claimed in claim 10, wherein the anti-freeze agent is ethylene glycol.

12. The fuel cell system as claimed in claim 1, wherein the fuel cell stack generates a DC output voltage that is adapted to be applied to a driving motor of an electrical vehicle.

13. The fuel cell system as claimed in claim 1, wherein the fuel cell stack generates a DC output voltage that is adapted to be applied to an alternating current power generation system comprising a direct current to alternating current converter and a voltage regulator.

14. The fuel cell system as claimed in claim 1, wherein the fuel cell stack generates a DC output voltage that is adapted to be applied to a direct current power generation system comprising a voltage regulator.
